(19) United States
(12) Patent Application Publication
(10) Pub. No.: US 2005/0201437 A1
(43) Pub. Date: Sep. 15, 2005

(54) Semiconductor laser

(76) Inventors: Benoit Reid, Orleans (CA); Ian Woods, Nepean (CA)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 11/001,736

(22) Filed: Dec. 2, 2004

Related U.S. Application Data
(63) Continuation-in-part of application No. 10/800,546, filed on Mar. 15, 2004.
(60) Provisional application No. 60/583,443, filed on Jun. 28, 2004.

(51) Int. Cl. H01S 3/10

(52) U.S. Cl. 372/43.01

(57) ABSTRACT

A semiconductor laser is provided having a plurality of layers. The semiconductor laser includes an active region, a P-type semiconductor body adjacent the active region including a P-type semiconductor confinement layer, and an N-type semiconductor body adjacent the active region opposite to the P-type semiconductor body. The N-type semiconductor body includes an N-type semiconductor confinement layer, an N-type semiconductor optical trap layer, and a semiconductor grating.

This application is a continuation-in-part of U.S. application Ser. No. 10/800,546, filed Mar. 15, 2004, and claims priority under 35 USC §119(e) to U.S. Provisional Application No. 60/583,443, filed Jun. 28, 2004. The entire disclosure of each of these applications is hereby incorporated herein by reference.

### FIELD OF THE INVENTION

This invention relates to semiconductor lasers, and more particularly to high power semiconductor lasers suitable for optical telecommunication applications.

### BACKGROUND OF THE INVENTION

Semiconductor lasers are typically formed from pn-junctions that have been enhanced to facilitate the efficient recombination of electron-hole pairs leading to the emission of radiation (light energy). A well known improvement to semiconductor lasers is the addition of a new layer of material between the P-type and N-type semiconductor layers, the new layer of material having a lower band gap energy than P-type and N-type layers. The layer formed by the material having the lower band gap energy is commonly referred to as the active region (or active layer) in a semiconductor laser.

Typically, a heterojunction refers to an interface between two different materials. Therefore, the insertion of an extra layer (active region) between the P-type and N-type layers results in what is known as a double heterostructure, as there will be a heterojunction at the interface of both the P-type and N-type materials. The doping in the active region is set at various levels depending upon the effect it is intended to have.

Thus, it is now common practice for semiconductor heterostructure lasers to be made up of three or more semiconductor layers. The simplest lasers include a P-type confinement region (P-type layer), an N-type confinement region (N-type layer) and an active region. The active region is typically made up of a number of layers and is located in the depletion region of the pn-junction between the P-type and N-type confinement regions. The optical mode is primarily confined in the active region (and the adjoining layers) because of the difference in the index of refraction between the active region, and the P-type and N-type confinement regions. The active region provides gain to the optical mode when the heterostructure is forward biased.

Light is generated within the active region once the semiconductor laser is forward biased and current is injected into the heterostructure. The active region is often composed of many layers in order to tailor the performance of the laser to meet the desired requirements (e.g. modulation bandwidth, power, sensitivity to temperature, etc.) of the laser's intended application.

The maximum optical output power of a semiconductor laser is usually limited by heating. The temperature of the active region increases with drive current, which degrades the laser performance. To achieve high optical power, one usually needs to increase the cavity length and the ridge width, which decreases the dissipated power density and keeps the laser from over heating. The power density is decreased because the electrical and thermal impedances decrease as the area where the current is injected increases.

When the cavity length is increased (typical cavity length is 2 mm for a high power laser), the efficiency (mW of optical power/mA of drive current) decreases because of internal optical loss in the cavity (that is not particular to the ridge structure, but is common in all structures). The optical loss is mainly due to the absorption of the light energy in the P-type material (region). Decreasing the overlap of the optical mode within the P-type region would then be a useful way to decrease the loss of light energy within the laser, which would enable the use of longer cavities to be used to create lasers with higher output power.

There are different structures that can be used to decrease the optical losses (i.e. losses of light energy). However, those structures usually decrease the optical mode size in the laser cavity. The drawback is that the far field of the optical mode (i.e. optical far field) gets wider and the optical power is more difficult to couple into an optical fiber. The optical far field and the optical mode in the laser cavity (the near field) are mathematically related by Fourier transform. This is a consequence of optical diffraction. Usually the optical far field is symmetric even though the near field is not. The loss in the coupling efficiency into the fiber happens only because the optical mode in the fiber and the laser far field do not have the same shape. An optical fiber can only accept a circular spot with a maximal divergence. The laser far field is usually elliptical and can have a large divergence.

For telecommunication applications it is the amount of optical power coupled into the fiber and not the raw optical power out of the laser that is significant. Thus, there is a need for a structure that simultaneously:
(1) has low optical losses, so that a long cavity can be used to achieve high output power;
(2) maintains a low divergence so that there is more power of the elliptical far field coupled into the optical fiber.

The active region is commonly made up of a number of layers, some of which are designed to be quantum wells (or bulk wells). A quantum well is designed to be a very thin layer, thus allowing a better localization of electrons in the conduction band and holes in the valence band that will enhance electron-hole pair recombination. When an electron-hole pair recombine the excess energy the electron had possessed is emitted as light (radiation) adding to the operation of the laser. Furthermore, reducing the band gap energy of the active region relative to the band gap energies of the two confinement layers improves the confinement of the electrons and holes to the active region; thus, the optical mode profile is guided to remain within a narrow spot. However, for lasers suitable for optical telecommunications, an optical mode profile that is too narrowly confined is difficult to couple into a fiber as it will have a wide far field. To achieve the best performance in a high-power laser, both the internal and external efficiency of the laser must be maximized. The internal efficiency of a laser is the efficiency at which electrical energy is converted into light energy (i.e. into the optical mode). The external efficiency is the efficiency at which the optical mode leaves the laser. However, there is a trade-off between the two measures of efficiency and thus far high power lasers have been limited by this trade off. Specifically, when considering semiconductor lasers, the external efficiency is largely the result of optical mode energy losses in P-type confinement layer, which tends to absorb much more optical energy than the active or N-type layers. On the other hand, internal efficiency (of semiconductor lasers) is usually dominated by current leakage which increases with temperature, and the temperature in turn increases with drive current. In other words, the electrical energy supplied to the laser is not maximally converted into optical energy within the laser as some current is dissipated through the semiconductor layers.

There is also another significant source of optical energy loss that must be taken into account when considering lasers for optical telecommunication applications. Semiconductor lasers used for optical telecommunication applications must have their outputs coupled to a fiber and as such it is common that lasers are commercially packaged with a short piece of fiber, known as a pigtail, already aligned to the output of the laser. Thus, for telecommunication applications the external efficiency of a laser should be measured to include the effects of industrial packaging. In this case that would mean that the external efficiency of a laser should be measured at the end of the pigtail so that coupling losses can be taken in account. In other words, the potential for coupling loss from the laser into the pigtail must be considered in the design of a laser to be used for optical telecommunication applications as coupling loss can be a significant contributor to the degradation of the external efficiency. Precise alignment of the laser output to the pigtail is not enough to solve this problem. Current high-power lasers have outputs that have a wide far field, due to attempt to confine the optical mode in the active region. This fact combined with the current use of small numerical aperture fibers required for reduced distortion optical transmissions create a situation where there is a significant optical mode energy loss to be accounted for when coupling the laser output into the fiber.

Semiconductor lasers following the above design characteristics are known in the art. One particular close example is disclosed in Reid U.S. Pat. No. 6,724,795 B2, assigned to the assignee of the present invention and incorporated herein by reference.

It would be desirable to have a high power semiconductor laser that was optimized to be internally efficient, experienced low optical energy losses within the laser and had an output beam with a narrow far field so that the beam could be coupled into a fiber with minimal optical coupling loss.

Gratings, often Bragg gratings, of various kinds have been implemented in such high power semiconductor lasers. The invention is related to edge-emitting high power and high reliability distributed feedback lasers. Most of such distributed feedback lasers on an n-doped substrate are designed with the grating on top of the active region in the p-clad of the waveguide. In a ridge waveguide structure, the grating is usually fabricated between a first and a second growth. Data suggests that to achieve a good reliability, a larger concentration of p-dopant is required than would be dictated solely by electrical requirements during the beginning of the second growth to compensate for residue at the interface with the first growth and the grating. A few problems exist due to this large concentration of p-dopant.

The p-dopant element that is usually used is zinc, which is a highly mobile atom and thus tends to diffuse readily in the structure. The second aspect is that active p-doping is a source of holes (lack of electrons), which can lead to a significant contribution to optical absorption in the waveguide, limiting the maximum cavity length than can be used. Use of longer cavity lengths is an important design tool for minimizing the heating in the laser. Consequently, limiting the cavity length can restrict device optical output power and reliability because these performance attributes are usually thermally or current density accelerated. In short, the p-dopant concentration imposed by placing the grating in the p-cladding limits optical output power and reliability.

It would thus be desirable to minimize the optical loss in a distributed feedback laser cavity independently from the grating process.

### SUMMARY OF THE INVENTION

As mentioned, this invention is directed to semiconductor lasers and applicable to lasers of the ridge waveguide type and of the buried heterostructure type. All such semiconductor lasers have or consist of a plurality of layers. The particular gist of this invention is to optimize the position and structure of one or more gratings within the semiconductor layers forming the laser. In short, the invention provides a semiconductor edge emitting distributed feedback laser comprising a grating and a low loss optical waveguide, where the optical loss and the grating fabrication can be optimized independently.

The invention will now be described by way of example and it should be understood that modifications, for example including the invention in a buried heterostructure, should not be seen as departing from the scope of the invention.

First the growth interface problem is solved by including the grating in the n-cladding of the optical waveguide below the active region as illustrated in the drawings. It is usually desirable to have a minimum thickness of InP on top of the grating to planarize the surface when growing the active region, which comprises quaternary semiconductor alloys like InGaAsP. The planar surface is desirable to maintain the stochiometry and minimize the number of defects, which is better for reliability. It is however conceivable that the active region also be grown following the geometry of the grating. Interface residue at this grating are much less an issue than when the grating is in the p-cladding since they can be easily compensated by higher n-doping, which does not contributed significantly to optical losses.

A second aspect of the invention is to minimize optical waveguide loss in the laser cavity. This is achieved by inserting one or more ballast layers in the n-cladding of the optical waveguide as shown in the drawings. The role of the ballast layers is to tilt the optical mode substantially towards the n-cladding, away from the p-cladding, to decrease the optical mode overlap with the lossy p-doped material. As will be understood by someone skilled in the art, although the ballast layers tilt the optical mode towards the n-cladding, the peak of the optical intensity is still substantially located in the active region.

A benefit of the ballast layers can be to increase the optical spot size, which then leads to narrower far field divergence, which helps optical coupling efficiency to optical fibers.

A benefit of the invention can be to enable the fabrication of DFB lasers with optical cavities longer than 2 mm to generate optical power larger than 100 mW at 90° C.

Another benefit of the invention can be to enable the fabrication of DFB lasers with optical cavities longer than 2 mm to operate the device at a small current density <5 kA/cm2 and low optical power <100 mW. Under those conditions, current and thermal acceleration of the degradation is lowered, which can lead to better device reliability without requiring accelerated device aging or burn-in, i.e. device stabilization under accelerated conditions.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

The invention will now be described in greater detail with reference to the accompanying drawings, in which:

FIG. 1A is a cross-sectional view of a semiconductor laser according to one embodiment of the invention;

FIG. 1B is a side view of the semiconductor laser illustrated in FIG. 1A;

FIG. 2 illustrates the mode profile of a laser without ballast layer and the improved mode profile with ballast layer;

FIG. 3 is a cross-sectional view of a semiconductor laser according to a second embodiment of the invention;

FIG. 4A, 4B, 4C illustrates a third embodiment of the invention;

FIG. 5 shows a fourth embodiment of the invention; and

### DETAILED DESCRIPTION OF THE PREFERRED EMBODIMENTS

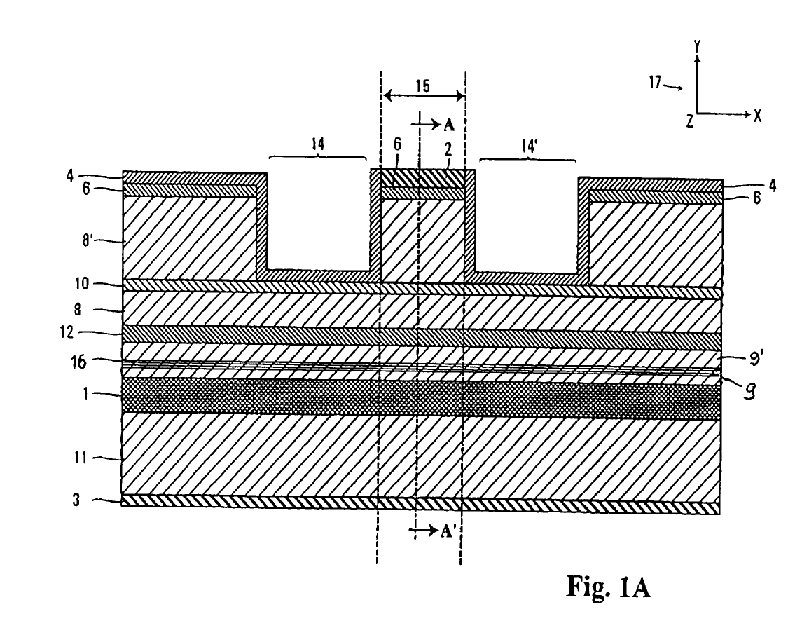

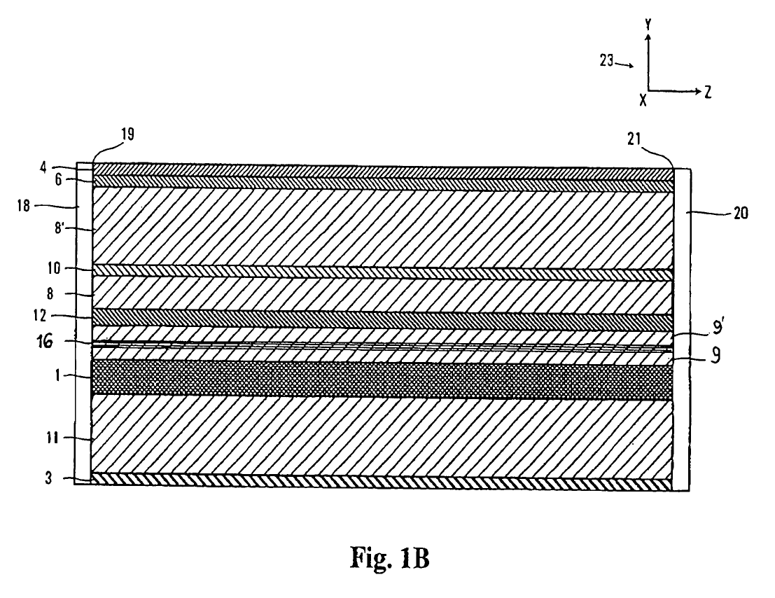

Referring to FIG. 1, shown is a high-power ridge waveguide semiconductor laser according to one embodiment of the invention. FIG. 1A shows a view in the direction of the laser beam, whereas FIG. 1B is a cross section along A-A′ as indicated in FIG. 1A. For brevity hereinafter the high-power ridge semiconductor laser will be simply referred to as the laser.

The laser consists of the following layers illustrated in FIG. 1 and listed in sequence:
a first metal contact layer 3;
an N-type substrate layer 11 (for example InP: indium phosphide);
an N-type optical trap or ballast layer 1 (for example InGaAsP: indium gallium arsenide and phosphide alloy), otherwise also referred to as a bulk waveguide layer;
a first N-type confinement layer 9 (for example N-doped InP);
a grating 16;
a second N-type confinement layer 9′ (for example N-doped InP);
an active region 12, that is typically made up of an i-type (but not necessarily) semiconductor alloy;
a first P-type confinement layer 8 (for example P-doped InP);
an etch-stop layer 10 (for example InGaAsP);
a second P-type (InP) confinement layer 8′ and a P-type contact layer 6 (for example, InGaAsP).

The P-type confinement layer 8′ and the P-type contact layer 6 are etched to create trenches 14 and 14′ that define a ridge structure 15; at least one dielectric layer 4 (there can be more than one dielectric layer) is then deposited over the exposed surfaces of the laser such that the dielectric material making up the at least one dielectric layer substantially evenly covers the exposed surface including the vertical edges of the trenches 14 and 14′, the dielectric material typically being an oxide or nitride compound; and, atop the ridge structure 15 a via (opening) is etched through the at least one dielectric layer 4, exposing the P-type contact layer 6, into which a second metal contact 2 is deposited such that it is in contact with P-type contact layer 6 on the ridge structure 15.

In some embodiments, the layers composing the active region may include quantum well layers (layers that are quite thin, about 10 atomic layers) and barrier layers between the quantum layers. Both, quantum wells and barrier layers are sandwiched on both sides by the P-type and N-type confinement layers 8 and 9 or 9′, resp., of the semiconductor laser. The confinement layers aid in funnelling electrons and holes into the quantum wells where recombination occurs, and the significant effect of recombination is that light is generated or equivalently radiation is emitted. This results in the index of refraction profile of the active region 12 having a high index of refraction in the quantum well layers and a lower index of refraction in the barrier layers.

Referring to the first and second P-type confinement layers 8 and 8′ and the etch-stop layer 10 shown in FIG. 1: the etch stop layer 10 is used in the manufacturing process of the laser to aid in the creation of trenches 14 and 14′. The etch stop layer 10 does not have a significant effect on the operation of the laser and as such the first and second P-type confinement layers 8 and 8′ effectively serve as one P-type confinement layer, with the etch stop layer 10 embedded within the one P-type confinement layer.

According to one embodiment of the invention, the grating 16 is placed within the N-type body, sandwiched between the confinement layers 9 and 9′. This grating now provides the desired effect that the optical loss in the laser cavity can be minimized independently from the grating process. Thus the invention provides the desired semiconductor edge-emitting distributed feedback laser in which the optical loss and the grating fabrication can be optimized independently.

The actual thickness of each of the aforementioned layers that make up the laser is found through empirical study for a particular application. However, the typical thickness or range can be provided here for the most important layers. It should be noted that the cross-sectional view shown in Figure is not to scale. The N-type substrate layer 11 is not important to the creation of and guiding of the optical mode, but it is required to provide a low electrical resistance mechanical support to the rest of the laser structure and as such it is typically 130 microns thick. The optical trap layer 1 is typically 0.05 to 0.25 microns thick. The N-type confinement layers 9 and 9′ may be slightly thicker, with a typical thickness ranging from 0.1 to 0.7 microns. The etch-stop layer 10 is also not important for the operation of the laser, but is present to protect the layer underneath it from the etching process used to create the trenches 14 and 14′.

The thickness of the grating layer is about 10 nm, i.e. 0.01 microns. It may be made from the same material or composition of materials as the ballast layer. InGaAs is a preferred material. As mentioned above, the ballast layers or optical superlattice layers have thicknesses in the range of 100 nm, i.e. 0.1 micron.

In this embodiment the thickness of the active region 12 typically does not need to exceed 0.1 microns, however can be increased to approximately 1.0 microns for exotic applications. The ridge structure 15 in which the P-type confinement layer 8′ is situated is typically 1.5 to 2.5 microns thick. The first metal contact layer 3 and the second metal contact layer 2 are designed to provide a low electrical resistance interface between connecting metals (such as gold or aluminium) to the laser. The thickness of each contact does not greatly impact the optical performance of the laser.

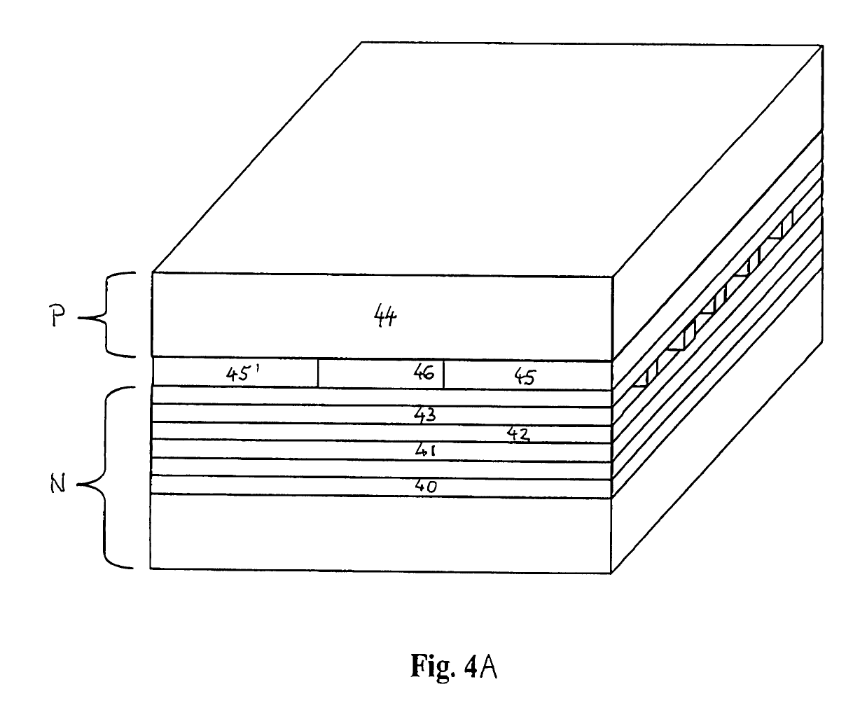

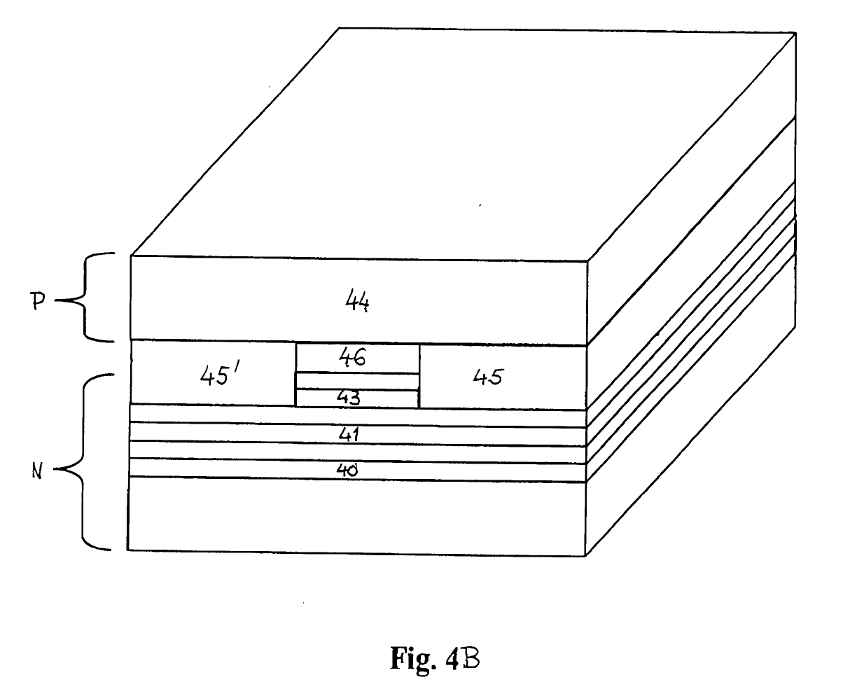

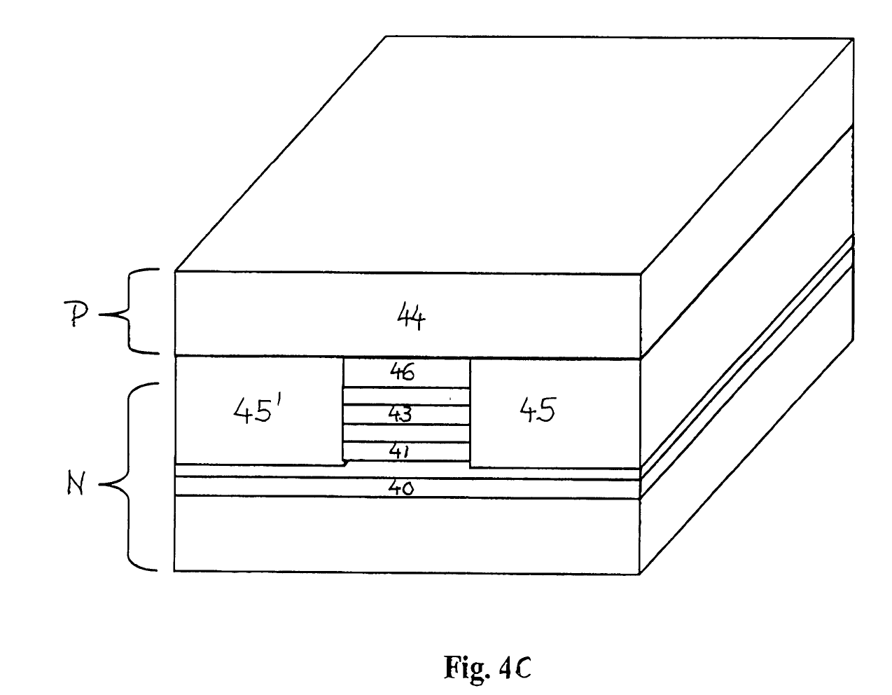

The primary advantage of the ridge structure is that it laterally confines the light in a single narrow optical mode that can be coupled into a telecommunication type optical fiber. There are other structures that can be used to achieve lateral confinement, for example a buried heterostructure as shown in FIGS. 4A to 4C, but the ridge is presently the simplest one to fabricate. The ridge width preferably is about 2-7 microns, but the laser width itself could be 250-500 microns, mostly for handling purposes. The typical cavity length (in the z direction) is in the range of 1-4 mm. The maximum ridge width is preferably about 7 microns. Beyond that, it is almost impossible to maintain a single stable optical mode. Furthermore, on top of the ridge, to ensure a good electrical contact to the laser a highly P-doped layer is used.

The following description of the preferred embodiment assumes the example material introduced above are used. However, other semiconductor materials that are suitable for lasers used in telecommunications applications may be used, for example gallium arsenide (GaAs).

With reference to an orthogonal co-ordinate system xyz indicated generally at 17, shown in FIG. 1 with the z-axis coming out of the page, the layer interfaces are parallel to each other and also parallel with the plane xz perpendicular to the line A-A′ defined in the y direction. The P-type confinement layer 8, the active region 12 and the N-type confinement layer 9 or 9′, resp., substantially define a heterostructure.

Referring to FIG. 1B, a side view of the semiconductor laser of FIG. 1A is shown. Laser action is achieved by cleaving the semiconductor heterostructure in two places along a crystallographic plane to form a resonating cavity with mirror facets 19 and 21. In the example given, the crystallographic plane is parallel with the yx plane. The facets are cleaved perpendicular to the direction of light propagation and the layers that make up the semiconductor heterostructure, i.e. along the yx plane. In some embodiments, the facets can be coated with dielectric materials 18, 20 to change the reflectivity. For laser applications, a first, preferably highly reflective, dielectric material with is used on one facet while the other facet is coated with a second dielectric material that is much less reflective.

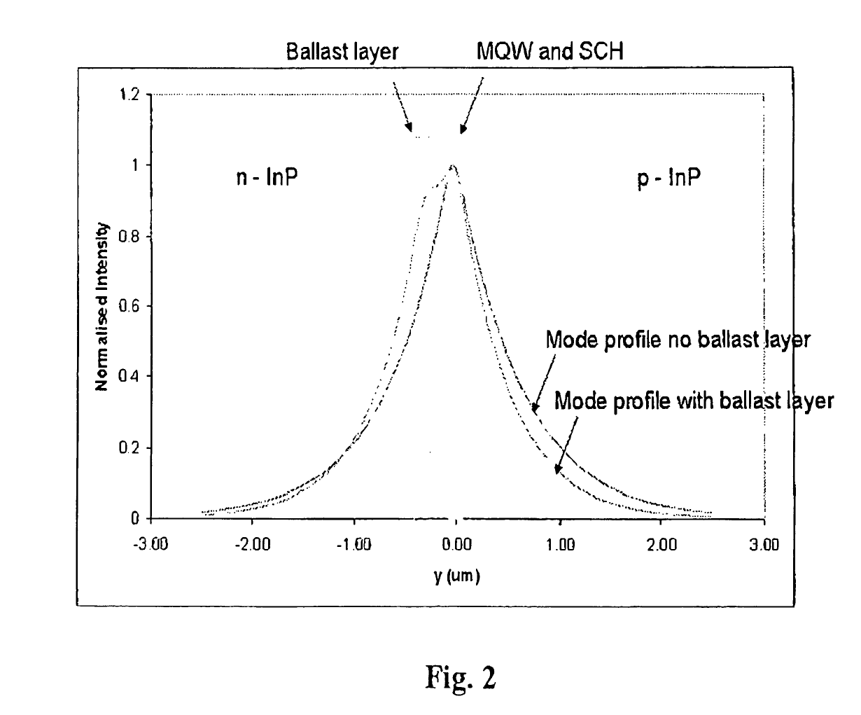

FIG. 2 illustrates a sample laser's intensity, i.e. the mode profile, over the laser's width. It is clearly visible that the mode profile with ballast layer (which can be replaced by an optical superlattice layer, as mentioned above) is preferable since it is much wider than the mode profile without ballast (or superlattice) layer. This wide near field beam results in the desired narrow far field distribution, thus facilitating the coupling into a fiber.

In the laser shown in FIG. 1A the active region 12 is assumed to be composed of quantum wells and barrier layers hence the index of refraction alternates between a higher value for the quantum well layers and a smaller value for the barrier layers. It is also well known to include in the active layer 12 sub-layers on either side of the outermost barrier layers. The sub-layers provide a gradual (stepped) increase in the index of refraction profile up to the value of the index of refraction of the barrier layers. The active region 12 has a refractive index profile that is in the range of 3.35 to 3.45, while the optical trap layer 1 has a refractive index n₁ of 3.31. The P-type confinement layer 8, the N-type confinement layer 9 and the N-type substrate 11 all have 3.16 as their refraction indices n₈, n₉, and n₁₁ respectively.

The refractive index 3.16 is that of InP (n₈, n₉ and n₁₁) and as such is fixed for a given wavelength. The other refractive indices vary with the InGaAsP composition that is used. Typically the index in the optical trap layer 1 would vary from 3.25 to 3.35. The refractive index of the active region 12 is approximately an average of the refractive indices of all layers that comprise it and generally would vary from 3.35 to 3.45.

Referring back to FIG. 1, the laser radiation, i.e. its light energy, is converted from the electrical energy carried by the injected carriers into the pn-junction (depletion region) that is within the heterojunction in the neighbourhood of the active region 12, specifically in the x direction under the ridge structure 15. The laser radiation of an optical mode travels in the z direction and positive current travels from the second metal contact 2 to the first metal contact 3 substantially parallel the line A-A′ when the heterojunction is forward biased.

As the optical mode is primarily generated in the active region 12, the active region 12 generally having the highest refractive index profile within the laser, the optical mode is substantially confined to the active region 12. The energy of the optical mode is confined in the horizontal direction to substantially a single spot by the ridge structure 15. A substantial amount of the energy of the optical mode traversing the N-type confinement layer 9 is gathered and is trapped in the optical trap layer 1. Normally without the optical trap layer, the optical mode would be evenly distributed throughout either side of the active region. Thus, the optical trap layer is breaking the symmetry of the optical mode energy distribution throughout the heterostructure as described in Reid U.S. Pat. No. 6,724,795 B2, mentioned above and incorporated herein by reference.

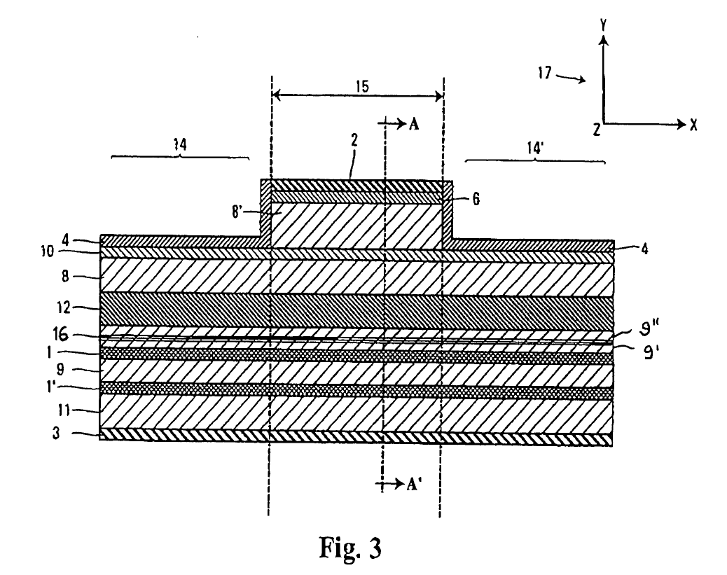

FIG. 3 shows a high-power ridge semiconductor laser according to a second embodiment of the invention. For brevity hereinafter the high-power ridge semiconductor laser will be simply referred to as the laser. The laser consists of the following layers (where the reference numbers of FIG. 1 are used to identify like elements), as illustrated in FIG. 3:
a first metal contact layer 3;
an N-type substrate layer 11;
two N-type optical trap layers 1 and 1′, otherwise referred to as the bulk waveguide layers; one or both of them may be optical superlattices as well;
between the optical trap layers 1 and 1′ there is a first N-type confinement layer 9;
above the optical trap layer 1 there is a second N-type confinement layer 9′;
a grating 16 is the next layer in this structure;
followed by a third N-type confinement layer 9″;
an active region (layer) 12, the active region being typically, but not necessarily, made up of i-type semiconductor material;
a first P-type confinement layer 8;
an etch-stop layer 10;
a second P-type confinement layer 8′ and a P-type InGaAs contact layer 6.
a P-type confinement layer 8′ and the P-type contact layer 6 are etched to create trenches 14 and 14′ that define a ridge structure 15;
at least one dielectric layer 4 is then deposited over the exposed surfaces of the laser such that the dielectric material making up the at least one dielectric layer substantially evenly covers the exposed surface including the vertical edges of the trenches 14 and 14′. The dielectric material typically is an oxide or nitrate compound.
atop the ridge structure 15 a via or opening is etched through the at least on dielectric layer 4, exposing the P-type contact layer 6, into which a second metal contact 2 is deposited such that it is in contact with P-type contact layer 6 on the ridge structure 15. The dielectric layer 4 typically is an oxide or nitrate compound;
a second metal contact 2 closes the structure.

The actual thickness of each of the aforementioned layers that make up the laser is found through empirical study for a particular application, as before for the first embodiment described in detail above. The optical trap layers 1 and 1′ are typically 0.05 to 0.25 microns thick. Each of the N-type confinement layers 9 and 9′ has a preferred thickness ranging from 0.1 to 0.7 microns. The etch-stop layer 10 is also not important for the operation of the laser. The etch-stop layer 10 is present to protect the layer underneath it from the etching process used to create the trenches 14 and 14′.

According to this second embodiment of the invention, the grating 16 is placed within the N-type body, sandwiched between the confinement layers 9′ and 9″, just below the active region 12. The grating 16 again provides the desired effect that the optical loss in the laser cavity can be minimized independently from the grating process. Thus the invention provides the desired semiconductor edge-emitting distributed feedback laser in which the optical loss and the grating fabrication can be optimized independently.

The thickness of the grating layer 16 is about 10 nm, i.e. 0.01 microns. It may be made from the same material or composition of materials as the ballast layer. InGaAs is a preferred material. As mentioned above, the ballast layers or optical superlattice layers have thicknesses in the range of 100 nm, i.e. 0.1 micron.

Using a semiconductor heterostructure described above for a laser, laser action is achieved by cleaving the semiconductor heterostructure in two places along a crystallographic plane forming a resonating cavity with mirror facets, as previously described for the first embodiment.

Referring again to FIG. 3, the laser radiation (light energy) is converted from the electrical energy carried by the injected carriers into the pn-junction that is within the heterojunction in the neighbourhood of the active region 12, specifically in the x direction under the ridge structure 15. The laser radiation travels in the z direction and positive current travels from the second metal contact 2 to the first metal contact 1 substantially along the line A-A′ when the heterojunction defined by layers 8, 12 and is forward biased.

As an optical mode is initially generated in the active region 12, the active region 12 having the highest refractive index n₁₂ within the laser, the optical mode is substantially confined to the active region 12. The energy of optical mode is also guided away from the P-type confinement layer 8 by the ridge structure 15 such that substantially more of the optical mode energy is guided towards and into the N-type confinement layer 9 adjacent to the opposite side of the active region 12. However, a substantial amount of the energy of the optical mode traversing the N-type confinement layer is 9 pulled further away from the active region 12 by the optical trap layers 1 and 1′. Each optical trap layer 1 and 1′ gathers and traps optical energy within it as a result of having higher refractive indices n₁ and n_{1′} relative to each of the refractive indices n₉, n₉ and n₁₁ corresponding to the N-type confinement layers 9 and 9′ and N-type substrate layer 11 respectively.

Common to both embodiments of the lasers, shown in FIGS. 1 and 3, is the fact that the optical mode generated by both lasers have asymmetric normalized optical intensity profiles in which the amount of energy traversing a P-type layer of a heterojunction within each laser is reduced in order to reduce the optical losses in the lossy P-type material. The peak of each normalized optical intensity profile remains within each respective active region, that comprise a portion of each respective heterojunction, allowing each respective optical mode to gain energy. At the same time the optical trap layers embedded within the N-type confinement layers cause the normalized optical intensity profile to flatten out on the N-type side of each respective heterojunction. This asymmetric normalized optical intensity profile is then not so narrow as to suffer from a wide far field and can be coupled into a fiber with minimal losses. In other words, because the normalized optical intensity profile is asymmetric, having a steep drop-off on the P-type side of the heterojunction and a gradual drop-off on the N-type side the heterojunction, the far field of the optical mode will be narrow and thus suffer from less coupling loss as compared to laser with a wide far field that is a result of having a symmetric and narrow normalized optical intensity profile. Thus the external efficiency measured at the end of a pigtail will increase substantially as compared to high-power lasers having a wide far field that have their beams coupled to a fiber for industrial packaging purposes as already described.

Further embodiments with more than two optical trap layers are within the scope of this invention. The laser is preferably embodied using a ridge structure on the P-type side of a heterojunction, as shown in the above examples. Alternatively, the ridge structure could be on the N-type side of the heterojunction.

FIGS. 4A to 4C show embodiments of the invention in lasers without a ridge structure, e.g. buried heterostructure waveguide lasers.

FIGS. 4A to 4C show various buried heterostructure laser structures. In these figures, like elements are denominated by the same reference numbers. The fabrication process of these lasers shall be described in the following. As will be apparent to a person skilled in the art, the function is essentially identical to the above described function of ridge waveguide lasers and thus needs no further description.

An active region 46 is fabricated by etching to create a ridge or mesa shape. The etching is done using chemical etching techniques such as reactive ion etching (RIE) or non-selective wet chemical etches. The active region 46 consists of a multi-quantum well (MQW) core bounded by separate confinement heterostructure (SCH) layers 41 and 41′. The MQW and SCH layers will be embedded in large bandgap semiconductor material, or cladding layer, such as indium phosphide and will consist of lower bandgap materials such as InGaAsP or InAlGaAs. The purpose of these layers is to provide optical waveguiding and gain to the optical mode.

Once the active region mesa is defined, blocking layers 45 and 45′ are grown using epitaxial crystallographic techniques such as Metal Organic Chemical Vapour Deposition (MOCVD) or Liquid Phase Epitaxy (LPE). These layers will typically be indium phosphide and will act as current blocking regions to ensure current flows through the active mesa (46) under device operation. The blocking layers 45 and 45′ can be semi-insulating, such as iron-doped InP, or grown as reverse bias pn-junctions, e.g. as successive layers of zinc and silicon doped InP.

Finally, a p-doped layer 44, typically InP and InGaAs, is grown over the active region mesa 46 and the blocking layers 45 and 45′ to provide ohmic contact to the metal contacts which are deposited after epitaxy is complete using evaporation, sputtering or electroplating processes. The ohmic contacts are not shown in the figures.

For the fabrication of distributed feedback (DFB) buried heterostructure lasers either immediately prior to or after the growth of the active region 46, a grating layer 43 is periodically etched using techniques such as holography or electron beam lithography and wet chemical etching. The grating layer 43 will consist of a material with higher refractive index compared to the cladding material, e.g. InGaAsP. Care is taken to ensure the composition of this material does not generate absorption at the operating wavelength of the laser. For a 1550 nm laser, the grating layer will typically have bandgap photoluminescence wavelengths of 1100 to 1200 nm. The periodic refractive index perturbation created by the etched grating layer provides the optical feedback necessary to generate lasing action in the device. Once etched, the grating layer is overgrown typically with an InP layer 42.

The ballast layers 41 and 40 are used to provide an independent means to optimize the laser waveguide structure and consist of material with higher refractive index compared to the cladding material, e.g. InGaAsP. As with the grating layer 43, care is taken to ensure the composition of this material does not generate absorption at the operating wavelength of the laser. For a 1550 nm laser, the ballast layers 41 and 40 will typically have bandgap photoluminescence wavelengths of 1000 to 1200 nm.

The grating layer 43 and the ballast layers 41 and 40 can be unchanged by the mesa etch process, as shown in FIG. 4A, or can be etched along with the active region during the definition of the mesa as shown in FIGS. 4B and 4C. The grating layer 43 can be a layer of the same thickness and composition as a ballast layer 41 or 40; but it may also be different. The functions of a grating layer 43 and a ballast layer 41 or 40 functions can be provided by just a single layer, combining both functions in single structure.

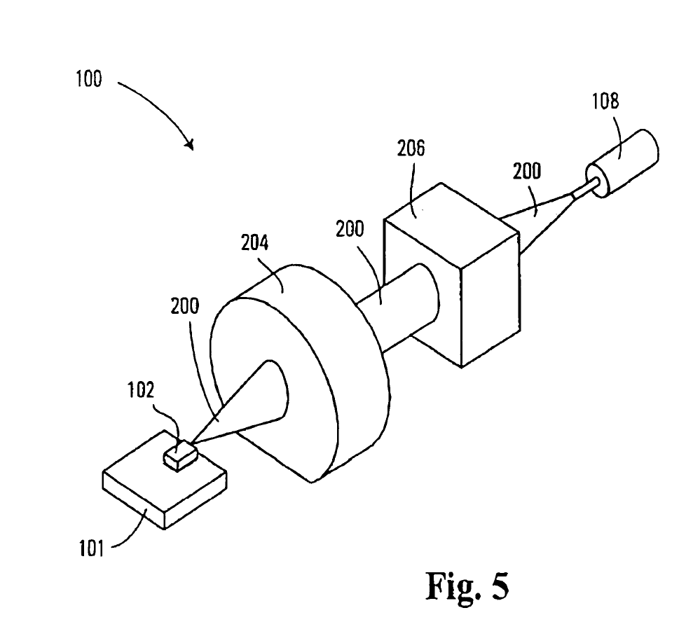

FIG. 5 shows a light-beam coupling configuration indicated generally at 100. A laser mount 101 mechanically supports a laser 102. The laser mount 101 also serves as a heat sink and a platform from which the laser 102 can draw electrical current. The output of the laser 102 is a light beam 200 that is substantially comprised of the optical mode previously discussed above. The light beam 200 is focused by a first lens 2 and then focused again by a second lens 206. The lens 206 focuses the light beam 200 into an optical fiber 108. The optical fiber 108 is a short length of optical fiber, a pigtail, or a longer piece of optical fiber. The light-beam coupling configuration 100 is typically packaged as a discrete component; however, it may also be integrated into an optical transceiver.

As previously described, the energy losses are a result of the fact that the laser emits a divergent elliptical beam, which poorly couples into a circular optical fiber that accepts only light from a particular cone. As a result of aspects of the invention disclosed it is possible to shape a far field that would have a full-width at half-maximum (FWHM) of 25 degrees in the y direction and a FWHM of 10 degrees in the x direction. The optical fiber requires that the light be within a cone of 15 degrees circular.

What has been described is merely illustrative of the application of the principles of the invention. Other arrangements and methods can be implemented by those skilled in the art without departing from the spirit and scope of the present invention. In particular should it not present a problem for those skilled in the art to apply the techniques described above to other laser designs, e.g. self-aligned stripe lasers or others. Specifically, other semiconductor optical devices, such as amplifiers and distributed feedback lasers or other devices containing gratings, can be constructed using the same semiconductor heterostructure as the embodiments of the semiconductor laser provided. The same structure maybe used to produce an amplifier by applying a low reflectivity coating to the facets.

1. A semiconductor laser with a plurality of layers, comprising:
an active region,
a P-type semiconductor body adjacent said active region including a P-type semiconductor confinement layer;
an N-type semiconductor body adjacent said active region opposite to said P-type semiconductor body, said N-type semiconductor body including
an N-type semiconductor confinement layer,
an N-type semiconductor optical trap layer, and
a semiconductor grating.

2. The semiconductor laser according to claim 1, wherein the P-type semiconductor body further comprises:
a P-type semiconductor confinement layer, wherein the P-type semiconductor confinement layer, the active region and N-type semiconductor confinement layer collectively comprise a heterostructure having a pn-junction (depletion region) substantially close to or within the active region;
a P-type contact layer;
at least one dielectric layer having a via etched through it providing electrical contact access to the P-type contact layer, and
a second metal contact layer contacting the P-type contact layer.

3. The semiconductor laser according to claim 2, wherein the types of the two bodies, P-type body and N-type body, are reversed.

4. The semiconductor laser according to claim 1, wherein
the N-type semiconductor optical trap layer has a higher refractive index than the average refractive index of the N-type semiconductor body and the N-type semiconductor confinement layer.

5. The semiconductor laser according to claim 1, wherein
the N-type semiconductor body contains an optical trap layer system made up of at least one optical trap and the grating.

6. The semiconductor laser according to claim 1, wherein
the grating is formed from or is an optical trap layer or one of the optical trap layers.

7. The semiconductor laser according to claim 1, wherein
the grating and the optical trap layer are made of different materials or material compositions and/or have different dimensions.

8. The semiconductor laser according to claim 1, wherein
the optical trap layer is an optical superlattice.

9. The semiconductor laser according to claim 8, wherein
the laser is a ridge waveguide laser and one or at least one of the optical trap layers is a superlattice.

10. The semiconductor laser according to claim 8, wherein
the laser is a buried heterostructure laser and one or at least one of the optical trap layers is a superlattice.

11. The semiconductor laser according to claim 1, wherein
the plurality of layers are cleaved in at least two places along a crystallographic plane, that is perpendicular to plane of the layers, forming a resonating cavity having mirror facets on both ends.

12. The semiconductor laser according to claim 1, wherein
the semiconductor laser produces, internally a laterally confined asymmetrical optical mode having a peak optical intensity substantially in the active region, the asymmetrical optical mode having an optical intensity distribution through the plurality of layers that has substantially more optical mode energy distributed within the N-type semiconductor body as compared to an amount of optical mode energy present in the P-type semiconductor body.

13. The semiconductor laser according to claim 1, wherein the active region comprises a plurality of quantum wells, each quantum well sandwiched between two barrier layers.

14. The semiconductor laser according to claim 1, further comprising an etch-stop layer embedded within the P-type semiconductor confinement layer.

15. The semiconductor laser according to claim 1, further comprising a ridge structure, wherein the P-type semiconductor confinement layer is substantially within the ridge structure.

16. The semiconductor laser according claim 15, wherein the P-type semiconductor confinement layer is partially within the ridge structure, the ridge structure laterally confining the asymmetrical optical mode.

17. The semiconductor laser according to claim 1, wherein
the grating layer, at least one of the optical trap layers, and/or the optical superlattice layer are made of the same material, in particular InGaAsP, or of the same composition of materials.

18. The semiconductor laser according to claim 1, wherein
the grating layer, and/or at least one of the optical trap layers, and/or the optical superlattice layer have approximately the same thickness.

19. The semiconductor laser according to claim 1, wherein
at least one of the optical trap layers and/or the optical superlattice are about 100 nm thick.

20. The semiconductor laser according to claim 1, wherein
the grating layer is about 10 nm thick.

21. The semiconductor laser of claim 1, wherein
the N-type semiconductor substrate layer is N-type InP.

22. The semiconductor laser of claim 1, wherein the N-type semiconductor optical trap layer is an N-type InGaAsP alloy.

23. The semiconductor laser of claim 1, wherein the N-type semiconductor confinement layer is N-type InP.

24. The semiconductor laser of claim 1, wherein the active region is substantially made up of an InGaAsP alloy.

25. The semiconductor laser of claim 1, wherein P-type semiconductor confinement layer is P-type InP.

26. The semiconductor laser of claim 1, further comprising below the N-type semiconductor optical trap layer at least one additional N-type semiconductor confinement layer and at least one additional N-type semiconductor optical trap layer.

27. The semiconductor laser of claim 1, wherein the N-type semiconductor optical trap layer comprises or consists of a plurality of layers.

28. The semiconductor laser according to claim 1 being a buried heterostructure waveguide laser.

29. The semiconductor laser according to claim 28, wherein
the active region is sandwiched between the P-type semiconductor body and the N-type semiconductor body, the optical mode being guided by blocking or confinement layers extending on both sides of said active region, said N-type semiconductor including a N-type semiconductor ballast layer and/or the grating.

30. The semiconductor laser according to claim 29, wherein the grating is closer to the active region than the ballast layers.

31. The semiconductor laser according to claim 29, wherein a plurality of ballast layers and the grating is located between said ballast layers.

32. The semiconductor laser according to claim 1 being a self-aligned stripe laser.

33. A laser internally generating an asymmetrical optical mode, the asymmetrical optical mode having a single maximum optical intensity peak and optical intensity distribution that has substantially more of the optical mode energy distributed to a first side of the single maximum optical intensity peak as compared to the amount of the optical mode energy on the second side of the single maximum optical intensity peak, said laser comprising
an active region,
a P-type semiconductor body adjacent said active region including a P-type semiconductor confinement layer,
an N-type semiconductor body adjacent said active region opposite to said P-type semiconductor body, said N-type semiconductor body including
an N-type semiconductor confinement layer,
an N-type semiconductor optical trap or ballast layer, and
a semiconductor grating,
said active region, said P-type semiconductor confinement layer, and N-type semiconductor confinement layer collectively comprising a heterostructure with a pn-junction (depletion region) substantially close to and within said active region.
